(19) United States
(12) Patent Application Publication
(10) Pub. No.: US 2023/0389563 A1
(43) Pub. Date: Dec. 7, 2023

(54) APPARATUS FOR MANUFACTURING YOGURT

(71) Applicant: Jeong Se Hee, Chungcheongnam-do (KR)

(72) Inventor: Jeong Se Hee, Chungcheongnam-do (KR)

(21) Appl. No.: 17/947,658

(22) Filed: Sep. 19, 2022

(30) Foreign Application Priority Data
Jun. 2, 2022 (KR) 10-2022-0067639

(51) Int. Cl. A23C 9/12

(52) U.S. Cl. CPC A23C 9/1226

(57) ABSTRACT

The present invention relates to an apparatus for manufacturing yogurt, an apparatus body part, a lid part coupled to the upper part of the apparatus body part and sealing the inside of the apparatus body part, and an apparatus disposed inside the apparatus body part to filter the whey of fermented milk It may be configured to include a filtering member for separating and removing to the inner bottom of the body portion, and a compression member connected to the inner upper portion of the lead portion and disposed inside the filtering member for compressing the fermented milk, and according to the present invention, it is easy and convenient to make Greek yogurt.

### RELATED APPLICATIONS

This application claims priority to and the benefit of Korean Patent Application No. 2022-0067639, filed on Jun. 2, 2022, the disclosure of which is incorporated herein by reference, in its entirety, for all purposes.

### FIELD OF THE INVENTION

The present disclosure relates to a yogurt manufacturing apparatus, and more particularly, to a yogurt manufacturing apparatus capable of manufacturing Greek yogurt easily, simply and quickly.

### BACKGROUND OF THE INVENTION

Greek yogurt is manufactured by concentrating fermented milk. Compared to regular yogurt, it has a firmer texture and can feel the rich taste of raw milk. In addition, it is rich in protein and calcium, which boosts immunity and is known to help intestinal health.

Various media also introduce Greek yogurt manufacturing methods. In a general method, raw milk and lactic acid bacteria are mixed and fermented, then filtered and concentrated through a sieve, and only the yogurt filtered through a sieve is scraped and manufactured.

However, most yogurt makers on the market have a problem in that it takes a long time to remove the whey from the fermented milk. This takes a considerable amount of time when preparing Greek yogurt at home, causing inconvenience to users.

### SUMMARY OF THE INVENTION

The present invention has been devised to solve the problems of the related art as described above, and an object of the present invention is to provide a yogurt manufacturing apparatus capable of manufacturing Greek yogurt easily, simply and quickly.

The technical problems to be solved by the present disclosure are not limited to the technical problems mentioned above, and other technical problems not mentioned can be clearly understood by those of ordinary skill in the art from the description below.

According to various embodiments of the present disclosure, the yogurt manufacturing apparatus may comprise a device body part; a lid unit coupled to an upper portion of the device body and sealing the inside of the device body; a filtering member disposed inside the device body part and separating the whey from the fermented milk into the inner bottom of the device body part; and a pressing member connected to the inner upper portion of the lid part and disposed inside the filter member for compressing the fermented milk.

According to an embodiment of the present application, the filter member may comprise a mesh frame disposed inside the device body and having a plurality of openings; a sieve disposed in the opening, to catch the whey of fermented milk; and a flange plate connected to the upper outer periphery of the mesh frame and seated on the stepped portion formed around the upper inner periphery of the device body portion, wherein the mesh frame and the strainer are insert injection-molded, yogurt manufacturing apparatus.

According to an embodiment of the present application, the yogurt manufacturing apparatus may further comprise a cover block coupled to the inside of the lid part and inserted into the upper part of the mesh frame to seal the inside of the mesh frame so that the fermented milk does not flow out to the upper part of the mesh frame.

According to an embodiment of the present application, the compression member may comprise a pressing means connected to the receiving groove formed on the inner upper part of the lid part, passing through the through hole formed in the central part of the cover block, and extending into the mesh frame; a pressing plate connected to the lower end of the pressing means and pressing the fermented milk accommodated in the mesh frame; and a seal disposed on the outer periphery of the pressing plate.

According to an embodiment of the present application, wherein the pressing means is a yogurt manufacturing apparatus is the coil spring.

According to an embodiment of the present application, the yogurt manufacturing apparatus may further comprise a fixing piece disposed on the outer periphery of the lid part; and a locking flange formed around the upper outer periphery of the device body part, wherein the fixing piece comprises: a deformable part connected to an outer periphery of the lid part; and a locking protrusion connected to the deformable part, the deformable part being deformed, and fastened to the locking flange.

According to an embodiment of the present application, wherein the pressurizing means may comprise a driving unit connected to the receiving groove formed on the inner upper portion of the lid part and disposed through a through hole formed in the central portion of the cover block; and a compression force control unit connected between the driving unit and the pressing plate and arranged to adjust the pressing force applied to the fermented milk by the pressing plate.

According to an embodiment of the present application, wherein the driving unit comprises: a motor mounted in the receiving groove and rotatable in both directions; a male screw portion formed on the shaft of the motor; a link beam having a shaft hole connected to the shaft formed in the central portion; and a female screw portion formed on an inner circumferential surface of the shaft hole and engaged with the male screw portion.

According to an embodiment of the present application, wherein the compression force control unit may comprise a block body connected to the link beam; a buffer spring disposed to connect the lower portion of the block body and the upper portion of the pressing plate, and buffering the force applied by the block body to the pressing plate; and a support protrusion disposed on the pressing plate and into which the lower portion of the buffer spring is inserted.

According to an embodiment of the present application, wherein the compression force control unit further comprises a load cell disposed in contact between the buffer spring and the upper portion of the pressing plate, wherein the control unit receives the pressure value measured by the load cell, determines whether the pressure value is within a preset pressure range for squeezing the fermented milk, and controls the motor to maintain the pressure value within the preset pressure range.

According to an embodiment of the present application, wherein the compression force control unit further comprises a guide part disposed on both sides of the block body, guiding the lifting movement of the block body, and fixing the position of the pressing plate.

According to an embodiment of the present application, wherein the guide unit comprises: a support bracket disposed on the pressing plate; a linear rail disposed on the side surface of the block body in the vertical direction; and a side guard disposed on the support bracket and having a link block connected to the linear rail.

According to an embodiment of the present application, wherein the guide unit further comprises, a limit block disposed under the link block on the linear rail, the limit block being in contact with the lower end of the link block, and limiting the elevating range of the linear rail.

According to an embodiment of the present application, wherein the filter member, in order to expand the fermented milk receiving range of the frame, the extension unit is disposed on the frame and extends the frame in a downward direction.

According to an embodiment of the present application, wherein the extension unit comprises, an extension frame connected to a lower portion of the mesh frame and having a plurality of openings to which the strainer is coupled; and a fixing means arranged in connection between the mesh frame and the extension frame, and fixing the upper and lower positions of the extension frame.

According to an embodiment of the present application, wherein the fixing means, an insertion groove formed on the side of the extension frame; a fixing spring having one end connected to the inner end of the insertion groove and disposed inside the insertion groove; a moving piece disposed in the insertion groove and connected to the other end of the fixing spring; a fixing pin disposed to protrude outwardly from the moving piece; an elevating groove disposed in the vertical direction on the side of the mesh frame; and a plurality of fixing grooves connected to the elevating groove and arranged at predetermined intervals along the vertical direction of the elevating groove, wherein the fixing pin moves in the vertical direction along the elevating groove, is inserted into any one of the plurality of fixing grooves, and fixes the vertical position of the extension frame.

According to an embodiment of the present application, wherein the fixing groove is connected to form an inclination angle (0) in the downward direction to the elevating groove, yogurt manufacturing apparatus.

According to the present invention, a user can easily and conveniently prepare Greek yogurt by simply putting fermented milk into the device and waiting for it.

In addition, since the pressing force is continuously applied to the fermented milk, the whey is rapidly drained from the fermented milk, and concentrated Greek yogurt can be prepared more quickly.

In addition, by operating the motor through the pressure value transmitted through the load cell to constantly maintain or change the compression force applied to the fermented milk, it is possible to reduce or manipulate the time to remove the whey from the fermented milk. This may allow the concentrated Greek yogurt to be prepared at the desired point in time by the user.

In addition, it is possible to maintain the position of the pressing plate for squeezing the fermentation rate even in the event of a user's mistake or external shock, so that yogurt production efficiency can be maintained even in an emergency.

In addition, it is possible to adjust the fermented milk receiving size, so that a large amount of fermentation rate can be concentrated at once to prepare Greek yogurt.

The effects obtainable through the present invention are not limited to the above-mentioned effects, and other effects not mentioned may be clearly understood by those of ordinary skill in the art to which the present invention belongs from the following description, will be.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a perspective view showing a yogurt manufacturing apparatus according to an embodiment of the present invention.

FIG. 2 is an exploded perspective view showing a first embodiment of the present invention yogurt manufacturing apparatus.

FIG. 3 is a side cross-sectional view showing a first embodiment of the present invention yogurt manufacturing apparatus.

FIG. 4 is an exploded perspective view showing a second embodiment of the present invention yogurt manufacturing apparatus.

FIG. 5 is a perspective view showing a compression force control unit in the second embodiment of the present invention yogurt manufacturing apparatus.

FIG. 6 is a side view showing the pressing force control unit in the second embodiment of the present invention yogurt manufacturing apparatus.

FIG. 7 is a side cross-sectional view showing a second embodiment of the present invention yogurt manufacturing apparatus.

FIG. 8 is a side view showing the expanded portion in the second embodiment of the present invention yogurt manufacturing apparatus.

### DETAILED DESCRIPTION

Advantages and features of the present invention and methods of achieving them will become apparent with reference to the embodiments described below in detail in conjunction with the accompanying drawings. However, the present invention is not limited to the embodiments disclosed below, but will be implemented in a variety of different forms, and only these embodiments allow the disclosure of the present invention to be complete, and common knowledge in the technical field to which the present invention belongs It is provided to fully inform the possessor of the scope of the invention, and the present invention is only defined by the scope of the claims.

The shapes, sizes, proportions, angles, numbers, etc. disclosed in the drawings for explaining the embodiments of the present invention are illustrative and the present invention is not limited to the illustrated matters. Like reference numerals refer to like elements throughout. In addition, in describing the present invention, if it is determined that a detailed description of a related known technology may unnecessarily obscure the subject matter of the present invention, the detailed description thereof will be omitted. When ‘including’, ‘having’, ‘consisting’, etc. mentioned in this specification are used, other parts may be added unless ‘only’ is used. When a component is expressed in the singular, the case in which the plural is included is included unless otherwise explicitly stated.

In interpreting the components, it is interpreted as including an error range even if there is no explicit description.

In the case of a description of the positional relationship, for example, when the positional relationship of two parts is described as ‘on’, ‘on’, ‘on’, ‘beside’, etc., ‘right’ Alternatively, one or more other parts may be positioned between two parts unless ‘directly’ is used.

Although first, second, etc. are used to describe various elements, these elements are not limited by these terms. These terms are only used to distinguish one component from another. Accordingly, the first component mentioned below may be the second component within the spirit of the present invention.

The same reference numerals refer to the same elements throughout.

The size and thickness of each component shown in the drawings are illustrated for convenience of description, and the present invention is not necessarily limited to the size and thickness of the illustrated component.

Each feature of the various embodiments of the present invention may be partially or wholly combined or combined with each other, and as those skilled in the art will fully understand, technically various interlocking and driving are possible, and each embodiment may be independently implemented with respect to each other, It may be possible to implement together in a related relationship.

Hereinafter, an embodiment according to the present invention will be described in detail with reference to the accompanying drawings. A plurality of embodiments described below may be repeatedly applied as long as they do not conflict with each other.

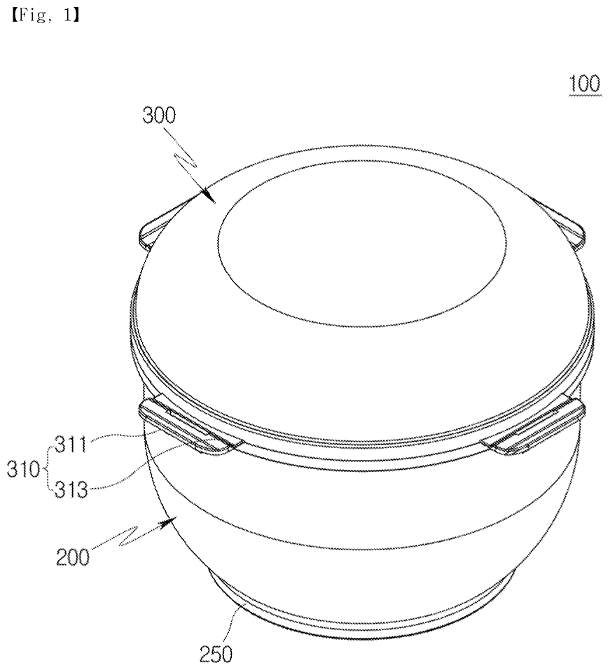

According to FIGS. 1 to 3, the yogurt manufacturing apparatus 100 according to the first embodiment of the present invention may include an apparatus body part 200, a lid part 300, a filtering member 400 and a pressing member 500. The device body part 200 may have a container shape having a predetermined space therein, and a pedestal 250 may be formed in the lower portion of the device body part 200 to be stably placed on the floor. A stepped part 220 may be formed on the upper inner periphery of the device body part 200, and a downwardly bent engaging flange 210 may be formed on the upper outer periphery of the device body part 200. And between the stepped part 220 and the engaging flange 210, the fitting line 230 protruding in the upward direction may be formed along the upper circumference of the device body part 200.

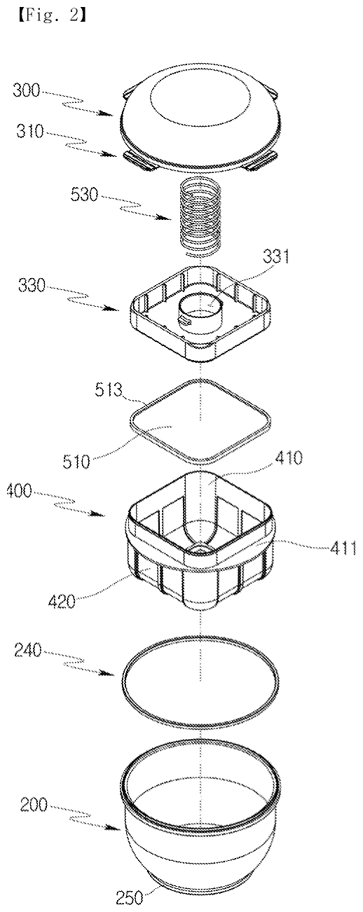

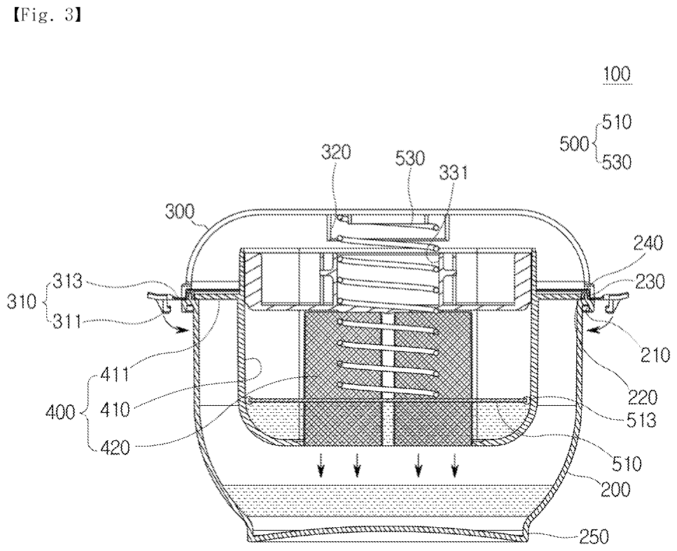

The lid part 300 may have a lid shape in which the central part is curved in a curved shape, may be coupled to the upper part of the device body, and may seal the inside of the device body part 200. Referring to FIGS. 2 and 3, an O-ring-shaped packing 240 may be provided in the embodiment of the present invention, and the packing 240 is fitted along the fitting line 230 and disposed along the fitting line 230 to seal the gap between the device body part 200 and the lid part 300. Here, the lid part 300 may include a fixing piece 310, a receiving groove 320, and a cover block 330. A plurality of fixing pieces 310 may be disposed at a predetermined interval on the outer periphery of the lid part 300, and the fixing pieces 310 are coupled to the engaging flange 210, and may have the function of binding the lid part 300 to the device body part 200. In an embodiment of the present invention, four fixing pieces 310 may be disposed at the same interval, but the present invention is not limited thereto. The fixing piece 310 may include a deformable part 313 and a locking protrusion 311. The deformable part 313 may be connected to the outer periphery of the lid part 300, may be formed of a soft material, such as thin plastic or rubber, and may be bent and deformed when a predetermined force is applied.

The locking protrusion 311 may be connected to the deformable part 313, and when the user holds the locking protrusion 311 and applies a force in the downward direction, the deforming part 313 is bent and the locking protrusion 311 may rotate in the downward direction. At this time, the user may insert the locking protrusion 311 into the engaging flange 210 so that the lid part 300 is coupled to the device body part 200. The receiving groove 320 may be formed in an inner central portion of the lid part 300. The upper end of the pressing member 500 may be connected to the inside of the receiving groove 320. The cover block 330 may be coupled to the inside of the lid part 300, and a through hole 331 may be formed in the central part. The pressing member 500 connected to the receiving groove 320 may be disposed to extend through the through hole 331 to press the fermented milk and extend into the filtering member 400.

On the other hand, the filtering member 400 may be disposed inside the device body part 200, and filter the whey of the fermented milk to be separated into the inner bottom of the device body part 200. The filtering member 400 may include a mesh frame 410, a strainer 420, and a flange plate 411. The mesh frame 410 may be disposed inside the device body part 200, and a plurality of openings may be formed. The sieve 420 is disposed in the opening, and may filter the whey of the fermented milk.

In an embodiment of the present invention, the mesh frame 410 and the strainer 420 may be integrally molded by an insert injection method. In a conventional yogurt maker, the mesh frame is separately injection-molded and then manufactured by using an adhesive to attach the strainer to the mesh frame. In this case, there was a problem in that the sieve was separated from the mesh frame in the process of use, and not only the whey of the fermented milk but also the concentrated yogurt was leaked and removed. In addition, if an adhesive that is harmful to the human body is used, the adhesive component may be contained in the yogurt and harm human health. In particular, if yogurt is manufactured for children in the household, it can be fatal to the health of children with weakened immune systems.

In the embodiment of the present invention, since the mesh frame 410 and the strainer 420 are integrally injection-molded, the above-described problem can be prevented. In addition, when the insert injection method is applied, the manufacturing process and manufacturing time can be shortened, and there is an effect that can reduce the manufacturing cost. The flange plate 411 may be disposed and connected to the upper outer periphery of the mesh frame 410, and may be seated on the stepped part 220 of the device body part 200. Accordingly, a predetermined space is formed between the lower position of the mesh frame 410 and the inner bottom surface of the device body part 200, and the whey separated through the sieve 420 can be accommodated in the predetermined space. The cover block 330 may be inserted into the upper portion of the mesh frame 410 to seal the inside of the mesh frame 410. The cover block 330 may prevent the fermented milk put in the mesh frame 410 from flowing out to the upper part of the mesh frame 410.

On the other hand, the pressing member 500 is connected to the inner upper portion of the lid part 300, is arranged to extend inside the filtering member 400, it is possible to press the fermented milk. If the fermented milk is naturally fermented and concentrated without additional pressure, it takes a considerable amount of time to remove the whey from the fermented milk. Therefore, in the embodiment of the present invention, by applying a predetermined pressure to the fermented milk with the pressing member 500 so that the whey is separated more quickly during the fermentation and concentration process, it is possible to shorten the manufacturing time of yogurt compared to the conventional yogurt maker. The pressing member 500 may include a pressing means 530 and a pressing plate 510. The upper end of the pressing means 530 may be connected to the receiving groove 320 formed on the inner upper portion of the lid part 300, and penetrates the through hole 331 formed in the central portion of the cover block 330, and may be extended and arranged into the interior of the mesh frame 410.

Referring to FIG. 2, in a first embodiment of the present invention, the pressing means 530 may be a coil spring. The pressing plate 510 may be connected to the lower end of the pressing means 530, and may apply pressure to the fermented milk accommodated in the mesh frame 410. That is, the pressing plate 510 presses the fermented milk by the elastic force of the coil spring, which is the pressing means 530. In this case, the pressing plate 510 may be formed with a cross-sectional area corresponding to the inner cross-sectional area of the mesh frame 410. In this case, it is possible to minimize the leakage of fermented milk through the gap between the pressing plate 510 and the mesh frame 410. And a sealing ring 513 may be fitted on the outer periphery of the pressing plate 510, and the gap between the pressing plate 510 and the mesh frame 410 is more sealed by the sealing 513 and prevents the outflow of fermented milk.

Referring to FIG. 3, a method of manufacturing Greek yogurt by the yogurt manufacturing apparatus 100 according to the first embodiment of the present invention is disclosed.

The user inserts the fermented milk inside the mesh frame 410 and covers the lid part 300 on the upper part of the device body part 200. At this time, when the user holds the fixing piece 310 to couple the lid part 300 to the upper part of the device body part 200 and rotates it downward, the deformable part 313 is formed and the locking protrusion 311 is fitted in the engaging flange 210 and the lid part 300 is coupled to the upper part of the device body part 200.

When the lid part 300 is coupled to the device body part 200, the coil spring and the pressing plate 510 which are the pressing means 530 connected to the receiving groove 320 of the lid part 300 is located inside the mesh frame 410.

The pressing plate 510 of embodiments comes into contact with the upper surface of the fermented milk, and when the coil spring applies an elastic force to the pressing plate 510, the pressing plate 510 presses the upper surface of the fermented milk. When the fermented milk is continuously pressurized for a predetermined time, the whey is removed through the sieve 420 as indicated by the arrow in the process of gradually fermenting and concentrating the fermented milk, and is collected on the inner bottom of the device body part 200. Unlike the conventional yogurt maker, the present invention uses a pressing force to remove such whey, so that it can be removed more quickly, thereby shortening the manufacturing time of Greek yogurt.

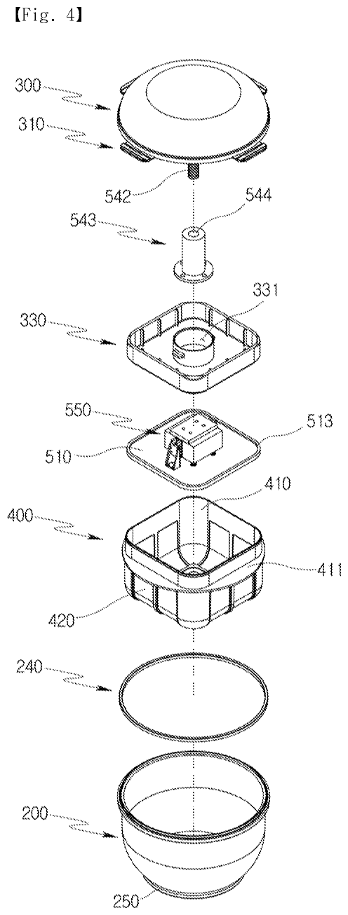

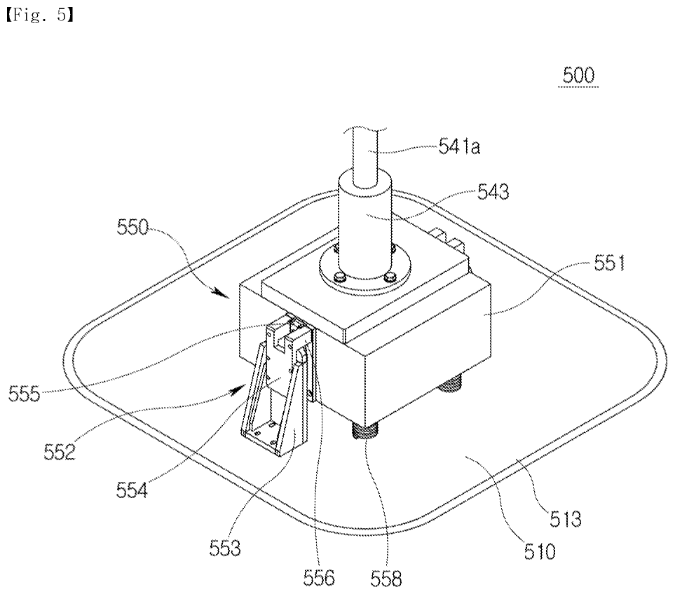

Meanwhile, referring to FIGS. 4 to 8, the yogurt manufacturing apparatus 100 according to the second embodiment of the present invention may include an apparatus body part 200, a lid part 300, a filtering member 400, and a pressing member 500. Since the configuration of the device body part 200 and the lid part 300 is the same as that of the first embodiment, reference is made to the configuration of the first embodiment described above, and the filtering member 400 and the pressing member 500 will be described below.

The pressing member 500 according to the second embodiment of the present invention is connected to the inner upper portion of the lid unit 300, is extended to the inside of the filtering member 400, and can compress fermented milk. For this sake, the pressing member 500 may include a pressing means 530 and a pressing plate 510.

The pressing means 530 may be connected to the receiving groove 320 formed on the inner upper portion of the lid part 300, penetrates the through hole 331 formed in the central part of the cover block 330, and is inside the mesh frame 410. It can be stretched and placed. Here, the pressing means 530 may include a driving unit 540 and a compression force adjusting unit 550.

The driving unit 540 may be coupled to the receiving groove 320 formed on the inner upper portion of the lid part 300, and may be disposed to pass through the through hole 331 formed in the central portion of the cover block 330. The driving unit 540 may elevate the compression force adjusting unit 550. The driving unit 540 may include a motor 541, a male screw part 542, a link beam 543, and a female screw unit 545. The motor 541 may be mounted in the receiving groove 320, and the shaft 541a of the motor 541 may be disposed to face downward.

In the embodiment of the present invention, the motor 541 may be rotated in both directions according to the instruction of the controller C. The male screw part 542 may be formed at the end of the shaft 541a of the motor 541. The link beam 543 may have a long rod shape, and a shaft hole 544 having a penetrating shape may be formed in the central portion. In addition, a female screw portion 545 engaged with the male screw part 542 may be formed on the inner peripheral surface of the shaft hole 544. The male screw part 542 and the female screw part 545 may be engaged with each other to connect the shaft 541a of the motor 541 and the link beam 543.

Meanwhile, the compression force control unit 550 is connected between the driving unit 540 and the pressing plate 510, and may perform a function of adjusting the pressing force applied by the pressing plate 510 to the fermented milk. The compression force control unit 550 may include a block body 551, a buffer spring 558, a support protrusion 558a, a load cell 559, and a guide part 552. The block body 551 may be connected to the link beam 543 and may have a rectangular parallelepiped shape in the embodiment of the present invention, but is not necessarily limited thereto. The buffer spring 558 may be disposed while connecting the lower portion of the block body 551 and the upper portion of the pressing plate 510. At this time, the support protrusion 558a is disposed on the upper portion of the pressing plate 510, the lower portion of the buffer spring 558 is inserted, and the position of the buffer spring 558 may be fixed.

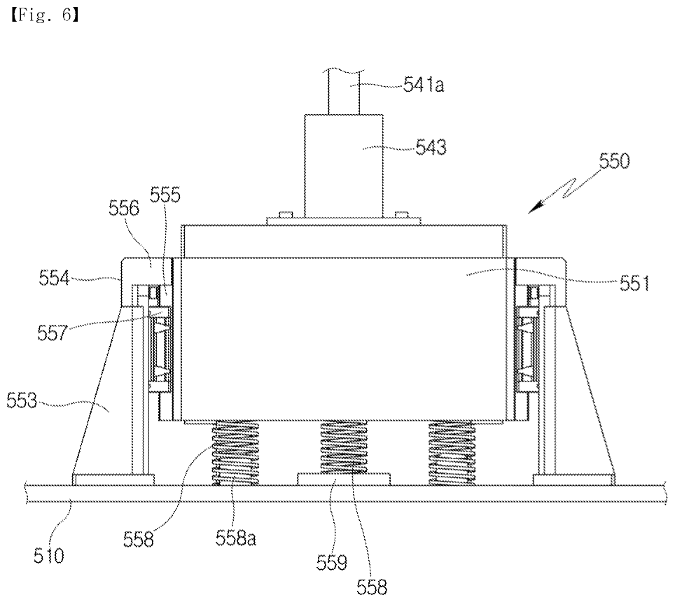

In embodiments of the present invention, a plurality of buffer springs 558 may be disposed, and referring to FIG. 6, the buffer springs 558 may be disposed at four edges and one at the center of the block body 551, but the present invention is not limited thereto. The buffer spring 558 can alleviate the occurrence of abrupt elevation of the pressing plate 510 when the motor 541 operates and the block body 551 is raised and lowered.

In addition, when the force applied by the block body 551 to the pressing plate 510 is too large, it can be absorbed by the compression force to prevent the strainer 420 from being damaged as the pressing plate 510 compresses the fermented milk excessively. The load cell 559 may be disposed in contact between the buffer spring 558 and the upper portion of the pressing plate 510.

When the motor 541 is operated, the shaft 541a of the motor 541 rotates, and accordingly, the link beam 543 connected to the shaft 541a of the motor 541 is lifted up and down in a screw manner. For example, it may be assumed that the link beam 543 descends when the motor 541 rotates in the forward direction, and it may be assumed that the link beam 543 rises when the motor 541 rotates in the reverse direction.

If the motor 541 rotates in the forward direction, the link beam 543 will descend, and the block body 551 connected to the lower portion of the link beam 543 will descend. When the block body 551 descends, the buffer spring 558 is connected to the lower part of the block body 551 and the upper part of the pressing plate 510 and is arranged to receive a compressive force.

Conversely, if the motor 541 rotates in the reverse direction, the link beam 543 will ascend, and the block body 551 connected to the lower part of the link beam 543 will ascend. When the block body 551 rises, it will be tensioned while the compression force received by the buffer spring 558 which is connected to the lower part of the block body 551 and the upper part of the pressing plate 510 is relieved.

The load cell 559 is disposed between the buffer spring 558 and the pressing plate 510 and measures the pressure applied to the pressing plate 510 according to the rotational direction of the motor 541. In embodiments, the measured pressure value is wirelessly transmitted to the controller C.

You can set the appropriate pressure range for compressing the fermented milk during the product manufacturing process or through the operation of the user's controller. In this case, there is a preset pressure range for compression, and through the pressure value sent from the load cell 559 to the controller C, the current buffer spring 558 applies the pressure value to the pressing plate 510 and A preset pressure range can be compared. If the measured pressure value deviates from the preset pressure range, the controller C may automatically adjust the rotation direction of the motor 541. Alternatively, information can be sent to a display or to the user's terminal, allowing the user to manually manipulate the controller.

For example, when the pressure value measured by the load cell 559 is lower than the preset pressure range, the controller C further rotates the motor 541 in the forward direction to set the pressure value of the load cell 559 to the preset pressure range. It can be maintained within the pressure range.

Conversely, when the pressure value measured by the load cell 559 is higher than the preset pressure range, the controller C rotates the motor 541 in the reverse direction so that the pressure value of the load cell 559 is maintained within the preset pressure range. Through the above method, the yogurt manufacturing apparatus 100 according to the second embodiment of the present invention can adjust the compression force applied to the fermented milk.

Meanwhile, the guide part 552 may be disposed on both sides of the block body 551, and guide the lifting movement of the block body 551 and at the same time fix the horizontal position of the pressing plate 510. The guide part 552 may include a support bracket 553, a linear rail 555, a side guard 554, and a limit block 557. The support bracket 553 may be disposed on the pressing plate 510.

In addition, a side guard 554 in which a link block 556 connected to the linear rail 555 is formed may be disposed on the support bracket 553. The side guard 554 may be fixed by bolting to the support bracket 553, but the present invention is not limited thereto. The linear rail 555 may be disposed on the side surface of the block body 551 in the vertical direction.

When the link beam 543 and the block body 551 move up and down according to the operation of the motor 541, the linear rail 555 connected to the block body 551 moves up and down together. At this time, since the linear rail 555 is connected to the link block 556, the lifting direction is accurately guided in the vertical direction by the side guard 554 and can be moved.

When the link beam 543 and the block body 551 move up and down according to the operation of the motor 541, the linear rail 555 connected to the block body 551 moves up and down together. At this time, since the linear rail 555 is connected to the link block 556, the lifting direction is accurately guided in the vertical direction by the side guard 554 and can be moved.

If the pressing plate 510 and the block body 551 are connected only by the buffer spring 558, the level of the yogurt manufacturing apparatus 100 is disturbed or the position is inclined due to a user's mistake, an external shock, etc. In this case, the position of the pressing plate 510 may be shifted. In this case, the sealing between the mesh frame 410 and the pressing plate 510 is misaligned, and the fermented milk may flow out to the upper portion of the pressing plate 510.

In the second embodiment of the present invention, since both sides of the block body 551 and the pressing plate 510 are connected by a pair of guide parts 552, respectively, it not only guides the elevation of the block body 551, even when shaking occurs in the yogurt manufacturing apparatus 100, the pressing plate 510 may maintain its original horizontal position inside the mesh frame 410. This allows the pressing plate 510 to continuously maintain the compression force for the fermented milk so that yogurt production efficiency is maintained even in an emergency.

Meanwhile, the limit block 557 may be disposed below the link block 556 on the linear rail 555. The limit block 557 is in contact with the lower end of the link block 556, it is possible to limit the lifting range of the linear rail 555. That is, the limit block 557 can prevent the tensile force exceeding the elastic modulus from being applied to the buffer spring 558 by limiting the elevating range of the block body 551.

On the other hand, the filtering member 400 according to the second embodiment of the present invention is disposed inside the apparatus body part 200, and filters the whey of the fermented milk so that it can be separated into the inner bottom of the apparatus body part 200. The filtering member 400 may include a mesh frame 410, a strainer 420, a flange plate 411, and an extension part 430. The mesh frame 410 may be disposed inside the device body part 200, and a plurality of openings may be formed. The sieve 420 is disposed in the opening and can catch the whey of the fermented milk.

As described in the first embodiment of the present invention, the mesh frame 410 and the strainer 420 may be integrally molded by an insert injection method. The flange plate 411 may be disposed and connected to the upper outer periphery of the mesh frame 410, and may be seated on the stepped part 220 of the device body part 200. Accordingly, a predetermined space is formed between the lower position of the mesh frame 410 and the inner bottom surface of the device body 200, and the whey separated through the sieve 420 can be accommodated in the predetermined space. The cover block 330 is inserted into the upper portion of the mesh frame 410 and may seal the inside of the mesh frame 410. The cover block 330 may prevent the fermented milk put in the mesh frame 410 from flowing out to the upper part of the mesh frame 410.

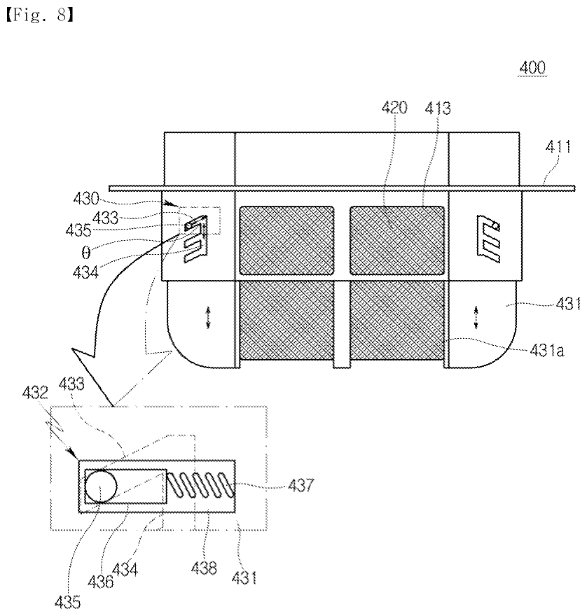

On the other hand, referring to FIG. 8, the extension part 430 may be disposed on the network frame 410 to expand the fermented milk receiving range of the network frame 410 and extend the network frame 410 downward. Here, the extension part 430 may include an extension frame 431 and a fixing means 432. The extension frame 431 is connected to the lower portion of the mesh frame 410, and an opening 431a of a penetrating shape may be formed. In the opening 431a, the sieve 420 may be integrally insert injection-molded. The sieve 420 disposed in the opening 431a of the extension frame 431 and the sieve 420 disposed in the opening 413 of the mesh frame 410 may function to filter the whey of the fermented milk together. The fixing means 432 is disposed in connection between the mesh frame 410 and the extension frame 431, and can fix the upper and lower positions of the extension frame 431.

The fixing means 432 may include an insertion groove 438, a fixing spring 437, a moving piece 436, a fixing pin 435, an elevating groove 434, and a fixing groove 433. The insertion groove 438 may be formed on the side of the extension frame 431. One end of the fixing spring 437 is connected to the inner end of the insertion groove 438, and the fixing spring 437 may be disposed inside the insertion groove 438. The moving piece 436 may be a block having a rectangular parallelepiped shape in the embodiment of the present invention, is connected to the other end of the fixing spring 437, and may be disposed inside the insertion groove 438. The size of the moving piece 436 disclosed in FIG. 8 may be changed to a size sufficient to allow the fixing spring 437 to be sufficiently compressed in the insertion groove 438. The fixing pin 435 may be a cylindrical rod in the embodiment of the present invention, and may be disposed to protrude outward from the moving piece 436. The elevating groove 434 may be disposed on the side of the mesh frame 410 in the vertical direction. In addition, a plurality of fixing grooves 433 may be connected at predetermined intervals along the vertical direction of the elevating grooves 434.

Referring to FIG. 8, the user can adjust the extension range of the extension frame 431 in the lower portion of the mesh frame 410 while holding the fixing pin 435 by hand and moving it in the vertical direction along the elevating groove 434. Depending on the amount of fermented milk, if the fixing pin 435 is positioned at the position of the fixing groove 433 that the user wants to expand and the fixing pin 435 is placed, the fixing spring 437 applies a tensile force to the moving piece 436, moving the fixing pin 435 to the inside of the fixing groove (433). After the fixing pin 435 is inserted into the fixing groove 433, the fixing pin 435 can no longer move in the vertical direction, so the position of the extension frame 431 in the lower part of the mesh frame 410 is fixed. The acceptance range of fermented milk is fixed. If the user wants to adjust again, holding the fixing pin 435 and pushing it in the direction of the elevating groove 434, the coil spring is compressed, and the fixing pin 435 is inserted into the elevating groove 434. Thereafter, the user can adjust the vertical position of the extension frame 431 while moving the fixing pin 435 along the elevating groove 434.

In the embodiment of the present invention, the fixing groove 433 may form a predetermined inclination angle θ in the downward direction with respect to the elevating groove 434. In this case, when the user wants to move the extension frame 431 in the upward direction and put it into the mesh frame 410, the user puts his or her hand on the bottom surface of the extension frame 431 and pushes it upward or the extension frame (431) is placed on the floor and the mesh frame 410 is pressed. At this time, the fixing pin 435 may move along the inclined direction of the fixing groove 433 and be inserted into the elevating groove 434. The inclined arrangement of the fixing groove 433 can be performed simply because it is not necessary to separately manipulate the fixing pin 435 by hand.

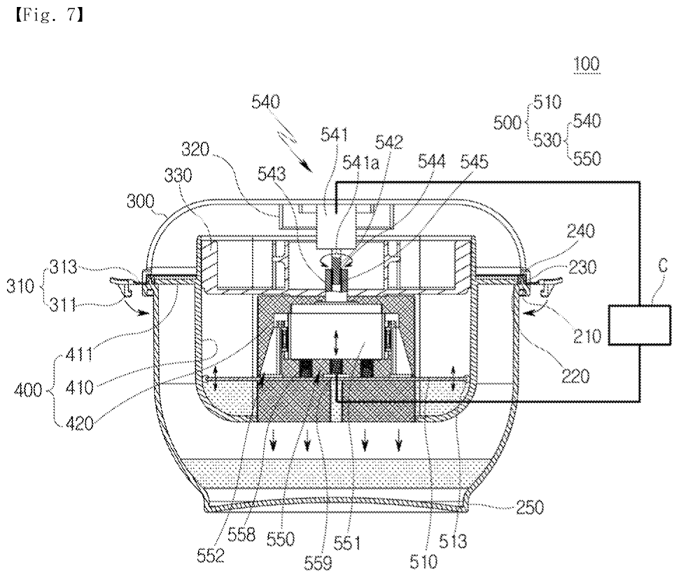

Meanwhile, referring to FIG. 7, a method for manufacturing Greek yogurt by the yogurt manufacturing apparatus 100 according to the second embodiment of the present invention is disclosed. The user puts the fermented milk inside the mesh frame 410 and covers the lid part 300 on the upper part of the device body part 200. At this time, when the user holds the fixing piece 310 to couple the lid part 300 to the upper part of the device body part 200 and rotates it downward, the deformable part 313 is formed and the locking protrusion 311 is the locking flange. It is fitted in the engaging flange 210 and the lid part 300 is coupled to the upper part of the device body part 200.

When the lid part 300 is coupled to the device body part 200, the compression force control unit 550 and the pressing plate 510 are positioned inside the mesh frame 410. The pressing plate 510 comes into contact with the upper surface of the fermented milk, and the compression force control unit 550 applies a force to the pressing plate 510 according to the operation of the motor 541. At this time, as described above, the buffer spring 558 absorbs the force as a compressive force depending on the situation between the block body 551 and the pressing plate 510 and transmits it to the pressing plate 510, thus it can prevent from excessive compression force being applied to the fermented milk.

When the pressing plate 510 continuously presses the fermented milk for a predetermined time, the whey is removed through the sieve 420 as shown by the arrow in the process of gradually fermenting and concentrating the fermented milk, and collects it on the inner bottom of the device part 200 will lose Unlike the conventional yogurt maker, the present invention uses a pressing force to remove such whey, so that it can be removed more quickly, thereby shortening the manufacturing time of Greek yogurt. The above is merely showing a specific embodiment of the yogurt manufacturing apparatus.

Therefore, within the limits that do not depart from the spirit of the present invention described in the following claims, the present invention can be substituted and modified in various forms, so that those of ordinary skill in the art can easily grasp that do.

What is claimed is:

1. A yogurt manufacturing apparatus comprising:
a device body part;
a lid unit coupled to an upper portion of the device body and sealing the inside of the device body;
a filtering member disposed inside the device body part and separating the whey from the fermented milk into the inner bottom of the device body part; and
a pressing member connected to the inner upper portion of the lid part and disposed inside the filter member for compressing the fermented milk.

2. The yogurt manufacturing apparatus according to claim 1, wherein the filter member further comprises:
a mesh frame disposed inside the device body and having a plurality of openings;
a sieve disposed in the opening, to catch the whey of fermented milk; and
a flange plate connected to the upper outer periphery of the mesh frame and seated on the stepped portion formed around the upper inner periphery of the device body portion,
wherein the mesh frame and the strainer are insert injection-molded, yogurt manufacturing apparatus.

3. The yogurt manufacturing apparatus according to claim 2, further comprising a cover block coupled to the inside of the lid part and inserted into the upper part of the mesh frame to seal the inside of the mesh frame so that the fermented milk does not flow out to the upper part of the mesh frame.

4. The yogurt manufacturing apparatus according to claim 3, wherein the compression member comprises:
a pressing means connected to the receiving groove formed on the inner upper part of the lid part, passing through the through hole formed in the central part of the cover block, and extending into the mesh frame;
a pressing plate connected to the lower end of the pressing means and pressing the fermented milk accommodated in the mesh frame; and
a seal disposed on the outer periphery of the pressing plate.

5. The yogurt manufacturing apparatus according to claim 4, wherein the pressing means is a coil spring.

6. The yogurt manufacturing apparatus according to claim 1, further comprising:
a fixing piece disposed on the outer periphery of the lid part; and
a locking flange formed around the upper outer periphery of the device body part,
wherein the fixing piece comprises:
a deformable part connected to an outer periphery of the lid part; and
a locking protrusion connected to the deformable part, the deformable part being deformed, and fastened to the locking flange.

7. The yogurt manufacturing apparatus according to claim 4, wherein the pressurizing means comprises:
a driving unit connected to the receiving groove formed on the inner upper portion of the lid part and disposed through a through hole formed in the central portion of the cover block; and
a compression force control unit connected between the driving unit and the pressing plate and arranged to adjust the pressing force applied to the fermented milk by the pressing plate.

8. The yogurt manufacturing apparatus according to claim 7, wherein the driving unit comprises:
a motor mounted in the receiving groove and rotatable in both directions;
a male screw portion formed on the shaft of the motor;
a link beam having a shaft hole connected to the shaft formed in the central portion; and
a female screw portion formed on an inner circumferential surface of the shaft hole and engaged with the male screw portion.

9. The yogurt manufacturing apparatus according to claim 8, wherein the compression force control unit:
a block body connected to the link beam;
a buffer spring disposed to connect the lower portion of the block body and the upper portion of the pressing plate, and buffering the force applied by the block body to the pressing plate; and
a support protrusion disposed on the pressing plate and into which the lower portion of the buffer spring is inserted.

10. The yogurt manufacturing apparatus according to claim 9, wherein the compression force control unit further comprises a load cell disposed in contact between the buffer spring and the upper portion of the pressing plate, and wherein the control unit receives the pressure value measured by the load cell, determines whether the pressure value is within a preset pressure range for squeezing the fermented milk, and controls the motor to maintain the pressure value within the preset pressure range.

11. The yogurt manufacturing apparatus according to claim 9, wherein the compression force control unit further comprises a guide part disposed on both sides of the block body, guiding the lifting movement of the block body and fixing the position of the pressing plate.

12. The yogurt manufacturing apparatus according to claim 11, wherein the guide unit comprises:
a support bracket disposed on the pressing plate;
a linear rail disposed on the side surface of the block body in the vertical direction; and
a side guard disposed on the support bracket and having a link block connected to the linear rail.

13. The yogurt manufacturing apparatus according to claim 12, wherein the guide unit further comprises,
a limit block disposed under the link block on the linear rail, the limit block being in contact with the lower end of the link block, and limiting the elevating range of the linear rail.

14. The yogurt manufacturing apparatus according to claim 2, wherein the filter member comprises:
an extension unit disposed on the mesh frame in order to expand the fermented milk receiving range of the mesh frame, and extending the mesh frame in a downward direction.

15. The yogurt manufacturing apparatus according to claim 14, wherein the extension unit comprises,
an extension frame connected to a lower portion of the mesh frame and having a plurality of openings to which the strainer is coupled; and
a fixing means arranged in connection between the mesh frame and the extension frame, and fixing the upper and lower positions of the extension frame.

16. The yogurt manufacturing apparatus according to claim 15, wherein the fixing means comprises,
an insertion groove formed on the side of the extension frame;
a fixing spring having one end connected to the inner end of the insertion groove and disposed inside the insertion groove;
a moving piece disposed in the insertion groove and connected to the other end of the fixing spring;
a fixing pin disposed to protrude outwardly from the moving piece;
an elevating groove disposed in the vertical direction on the side of the mesh frame; and
a plurality of fixing grooves connected to the elevating groove and arranged at predetermined intervals along the vertical direction of the elevating groove,
wherein the fixing pin moves in the vertical direction along the elevating groove, is inserted into any one of the plurality of fixing grooves, and fixes the vertical position of the extension frame.

17. The yogurt manufacturing apparatus according to claim 16, wherein the fixing groove is connected to form an inclination angle (θ) in the downward direction to the elevating groove.
